(19) United States
(12) Patent Application Publication
(10) Pub. No.: US 2013/0155573 A1
(43) Pub. Date: Jun. 20, 2013

(54) ELECTRONIC COMPONENT AND MANUFACTURING METHOD THEREOF

(71) Applicant: Samsung Electro-Mechanics., CO., LTD., Suwon (KR)

(72) Inventors: Hyun Tae Kim, Gyunggi-do (KR); Hee Jung Jung, Gyunggi-do (KR); Dae Bok Oh, Gyunggi-Do (KR); Sang Hoon Kwon, Gyunggi-Do (KR); Seoung Ho Kim, Gyunggi-Do (KR); Jong Woo Choi, Gyunggi-Do (KR)

(73) Assignee: Samsung Electro-Mechanics CO., LTD., Suwon (KR)

(21) Appl. No.: 13/720,405

(22) Filed: Dec. 19, 2012

(30) Foreign Application Priority Data
Dec. 19, 2011 (KR) 10-2011-0137251

(51) Int. Cl. H01G 13/00; H01G 4/008

(52) U.S. Cl. CPC H01G 13/00; H01G 4/0085
USPC 361/305; 427/79

(57) ABSTRACT

There is provided an electronic component including a ceramic sintered body having a plurality of internal electrodes formed therein, and external electrodes formed on an outer surface of the ceramic sintered body. Each of the external electrodes includes a copper (Cu) electrode layer electrically connected to the internal electrodes, a copper (Cu)-tin (Sn) alloy layer formed on an outer surface of the electrode layer, and a tin (Sn) plating layer formed on an outer surface of the alloy layer.

### CROSS-REFERENCE TO RELATED APPLICATIONS

This application claims the priority of Korean Patent Application No. 10-2011-0137251 filed on Dec. 19, 2011, in the Korean Intellectual Property Office, the disclosure of which is incorporated herein by reference.

### BACKGROUND OF THE INVENTION

1. Field of the Invention

The present invention relates to an electronic component having high reliability and a manufacturing method thereof.

2. Description of the Related Art

In general, an electronic component utilizing a ceramic material such as a capacitor, an inductor, a piezoelectric element, a varistor, a thermistor, and the like includes a ceramic main body formed of a ceramic material, internal electrodes formed in the main body, and external electrodes provided on an outer surface of the ceramic main body so as to be connected to the internal electrodes.

Among the ceramic electronic components, a multilayer ceramic capacitor includes a plurality of laminated dielectric layers, internal electrodes disposed to face each other with the dielectric layer interposed therebetween, and external electrodes electrically connected to respective internal electrodes.

The multilayer ceramic capacitor is able to ensure high capacity despite its compact size, and it is easily mounted, thereby being widely used as a component in a mobile communications apparatus such as a computer, a PDA, a mobile phone, and the like.

In line with a reduction in the size of, and the multifunctionalization of electronic devices, chip components have also been reduced in the size and been multifunctionalized, so that small, high capacity multilayer ceramic capacitors are in demand.

In this regard, a reduction in size and an increase in capacitance of the multilayer ceramic capacitor have been attempted by reducing a thickness of an external electrode while retaining the overall chip size.

Also, in recent years, when the multilayer ceramic capacitor is mounted on a substrate, a method of forming a nickel/tin (Ni/Sn) plating layer on the external electrode has been used to facilitate the connection thereof with the substrate.

In the related art, to form the above-described plating layer, an electroplating using a plating solution, or the like has been mainly used.

However, when the plating process is performed using the plating solution, the plating solution may be penetrated into a multilayer ceramic electronic component during the plating process, the multilayer ceramic electronic component may be damaged due to hydrogen gas generated at the time of the plating.

Accordingly, there are demands for a method of easily forming the plating layer on the external electrode without using the plating solution.

### SUMMARY OF THE INVENTION

An aspect of the present invention provides an electronic component and a manufacturing method thereof that can allow for a plating layer to be formed on an external electrode without using a plating solution.

According to an aspect of the present invention, there is provided an electronic component, including: a ceramic sintered body having a plurality of internal electrodes formed therein; and external electrodes formed on an outer surface of the ceramic sintered body, wherein each of the external electrodes includes a copper (Cu) electrode layer electrically connected to the internal electrodes, a copper (Cu)-tin (Sn) alloy layer formed on an outer surface of the electrode layer, and a tin (Sn) plating layer formed on an outer surface of the alloy layer.

The alloy layer may include nickel (Ni).

The plating layer may include bismuth (Bi).

According to another aspect of the present invention, there is provided an manufacturing method of an electronic component, including: preparing a ceramic sintered body; forming at least one electrode layer on an outer surface of the ceramic sintered body; forming an alloy layer by a primary dipping process of dipping the electrode layer in a first molten solder; and forming a plating layer by a secondary dipping process of dipping the alloy layer in a second molten solder.

The electrode layer may be formed of copper (Cu).

The first molten solder may be formed of a composition including nickel (Ni), copper (Cu), and tin (Sn).

The alloy layer may be formed of a copper (Cu)-tin (Sn) alloy including nickel (Ni).

The second molten solder may be formed of a composition including tin (Sn) and bismuth (Bi).

The plating layer may be a tin (Sn) plating layer including bismuth (Bi).

The primary dipping process may be performed by using the first molten solder having a high temperature, and the secondary dipping process may be performed by using the second molten solder having a low temperature.

The first molten solder may be melted at a temperature of 260° C. or higher, and the second molten solder may be melted at a temperature of 220° C. or lower.

The primary dipping process may be performed for a shorter time than that of the secondary dipping process.

The electronic component may be a multilayer ceramic capacitor.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing an electronic component according to an embodiment of the present invention;

FIG. 2 is a cross-sectional view taken along line A-A′ of FIG. 1;

FIG. 3 is a flowchart schematically showing a manufacturing method of the electronic component shown in FIG. 1; and

FIGS. 4A to 4C are cross-sectional views for describing the manufacturing method of the electronic component of FIG. 3.

### DETAILED DESCRIPTION OF THE EMBODIMENTS

Prior to a detailed description of the present invention, the terms or words, which are used in the specification and claims to be described below, should not be construed as having typical or dictionary meanings. The terms or words should be construed in conformity with the technical idea of the present invention on the basis of the principle that the inventor(s) can appropriately define terms in order to describe his or her invention in the best way. Embodiments described in the specification and structures illustrated in drawings are merely exemplary embodiments of the present invention. Thus, it is intended that the present invention covers the modifications and variations of this invention, provided they fall within the scope of their equivalents at the time of filing this application.

Exemplary embodiments of the present invention will be described in detail with reference to the accompanying drawings. The same reference numerals will be used throughout to designate the same or like components in the accompanying drawings. Moreover, detailed descriptions related to well-known functions or configurations will be ruled out in order not to unnecessarily obscure subject matters of the present invention. In the drawings, the shapes and dimensions of some components may be exaggerated, omitted or schematically illustrated. Also, the size of each component does not entirely reflect an actual size.

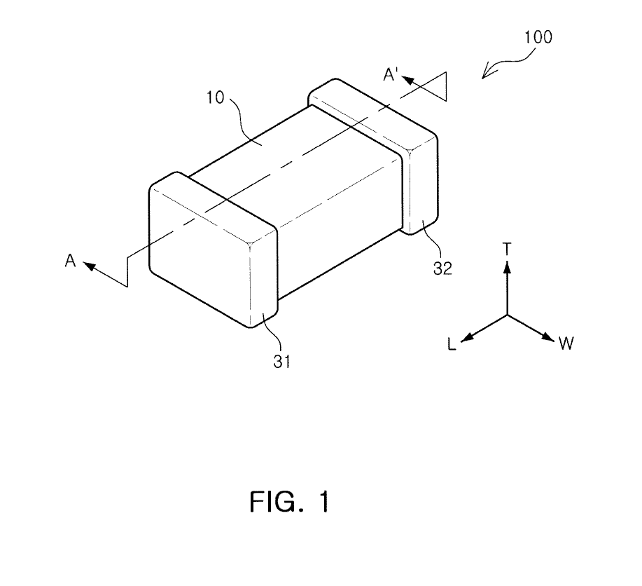

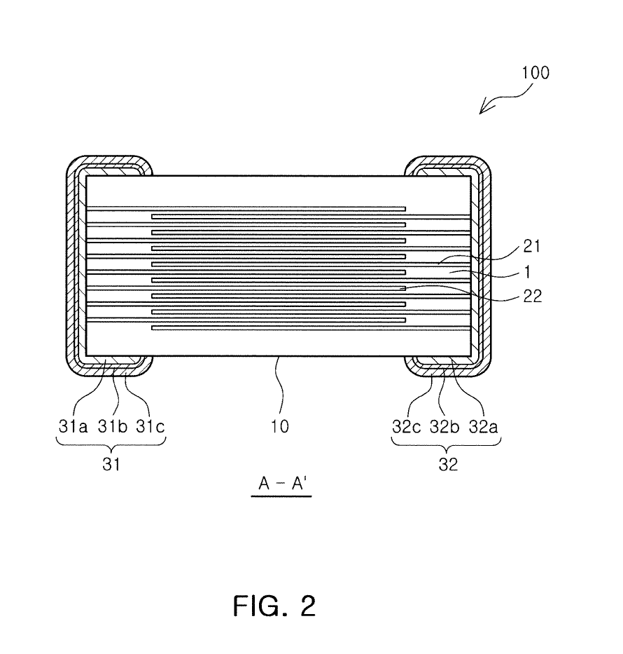

FIG. 1 is a perspective view schematically showing an electronic component according to an embodiment of the present invention, and FIG. 2 is a cross-sectional view taken along line A-A′ of FIG. 1.

Referring to FIGS. 1 and 2, an electronic component 100 according to an embodiment of the present invention is a multilayer ceramic capacitor, and includes a ceramic sintered body 10, internal electrodes 21 and 22, and external electrodes 31 and 32.

The ceramic sintered body 10 is obtained by laminating a plurality of dielectric layers 1 and then sintering the laminated dielectric layers 1. The adjacent dielectric layers 1 are integrated such that a boundary therebetween may not be readily apparent. The ceramic dielectric layer 1 may be formed of a ceramic material having a high dielectric constant; however, the present invention is not limited thereto. That is, the dielectric layer 1 may be formed of a barium titanate material (BaTiO₃), a lead complex perovskite material, a strontium titanate material (SrTiO₃), or the like.

The internal electrodes 21 and 22 are formed inside the ceramic sintered body 10, and the external electrodes 31 and 32 are formed on an outer surface of the ceramic sintered body 10.

Each of the internal electrodes 21 and 22 may be interposed between the plurality of dielectric layers 1 in the process of laminating the plurality of dielectric layers 1.

The pair of internal electrodes 21 and 22 having different polarities may be alternately arranged to face each other in a direction in which the plurality of dielectric layers 1 are laminated, to thereby be electrically isolated from each other by the plurality of dielectric layers 1.

Ends of the internal electrodes 21 and 22 alternately exposed to ends of the ceramic sintered body 10. In this case, the ends of the internal electrodes 21 and 22 exposed to the ends of the ceramic sintered body 10 are electrically connected to the external electrodes 31 and 32, respectively.

The internal electrodes 21 and 22 may be formed of a conductive metal material. Here, the conductive metal is not particularly limited, for example, silver (Ag), lead (Pb), platinum (Pt), nickel (Ni), copper (Cu), or the like may be used alone or in a combination of two or more thereof.

The external electrodes 31 and 32 may be formed to be electrically connected to the ends of the internal electrodes 21 and 22 exposed to the ends of the ceramic sintered body 10. Accordingly, the external electrodes 31 and 32 may be respectively formed in the ends of the ceramic sintered body 10.

The external electrodes 31 and 32 according to the present embodiment may include electrode layers 31a and 32a, alloy layers 31b and 32b, and plating layers 31c and 32c.

The electrode layers 31a and 32a may be formed of copper (Cu). Accordingly, the electrode layers 31a and 32a according to the present embodiment may be formed in a manner such that a conductive paste containing a copper (Cu) powder is coated on the outer surface of the ceramic sintered body 10 and then fired. Here, the application of the conductive paste is not particularly limited, and various methods such as dipping, painting, printing, and the like may be used.

The alloy layers 31b and 32b are formed on outer surfaces of the electrode layers 31a and 32a. When the plating layers 31c and 32c are formed of a high temperature molten solder by a dipping method, the alloy layers 31b and 32b according to the present embodiment are provided so as to suppress the copper electrode layers 31a and 32a from being leached by the molten solder during the dipping process.

In general, since the molten solder in which tin (Sn) is melted has a high temperature, when the electrode layers 31a and 32a formed of copper (Cu) are dipped therein, the copper (Cu) electrode layers 31a and 32a are leached by the molten solder. Accordingly, in this case, the thickness of the electrode layers 31a and 32a may be reduced in proportion to time during which the electrode layers 31a and 32a are dipped in the molten solder.

In order to suppress the electrode layers 31a and 32a from being leaching, the electronic component 100 according to the present embodiment includes the alloy layers 31b and 32b formed prior to the formation of the plating layers 31c and 32c, so that the alloy layers 31b and 32b are interposed between the electrode layers 31a and 32a and the plating layers 31c and 32c.

The alloy layers 31b and 32b according to the present embodiment may be formed of a copper (Cu)-tin (Sn) alloy containing nickel (Ni). Here, nickel (Ni) is contained to suppress the copper (Cu)-tin (Sn) alloy from being excessively grown by heat.

When heat is applied to the alloy layers 31b and 32b in a state in which nickel (Ni) is not contained in the alloy layers 31b and 32b, the alloy layers 31b and 32b are continuously grown, so that all of the electrode layers 31a and 32a and the plating layers 31c and 32c may be transformed into the alloy layers 31b and 32b. In this case, electrical conductivity is sharply decreased, so that the electronic component 100 may be difficult to properly perform the functions thereof.

Accordingly, in order to suppress the electrode layers 31a and 32a or the plating layers 31c and 32c from being transformed into the alloy layers 31b and 32b, the electronic component 100 according to the present embodiment allows the alloy layers 31b and 32b to contain a small amount of nickel (Ni). The nickel (Ni) is contained in the alloy layers 31b and 32b, so that the growth of the copper (Cu)-tin (Sn) alloy layers 31b and 32b may be suppressed even in the case that heat is applied thereto, whereby the electrode layers 31a and 32a and the plating layers 31c and 32c may be continuously maintained in their own state.

The plating layers 31c and 32c are formed in the outer surfaces of the alloy layers 31b and 32b. The plating layers 31c and 32c are provided to facilitate the bonding of the electronic component 100 according to the present embodiment to an electrode formed on a substrate (not shown). Accordingly, the plating layers 31c and 32c may be formed of a material which may be easily bonded to the electrode of the substrate in the bonding process using a solder, or the like.

In particular, the plating layers 31c and 32c according to the present embodiment may be formed of a tin (Sn) material containing a small amount of bismuth (Bi). Here, the bismuth (Bi) is provided to reduce a temperature of the molten solder in the manufacturing process of the electronic component 100 according to the present embodiment. This will be described in detail in the manufacturing method of the electronic component 100 to be described later.

In the case of the electronic component 100 according to the present embodiment, the alloy layers 31b and 32b and the plating layers 31c and 32c are formed by the dipping method using the molten solder.

In the case in which the alloy layers 31b and 32b and the plating layers 31c and 32c are formed through the dipping method, a plating solution is not used unlike the related art. Accordingly, the plating solution may not penetrate into the electronic component 100, or the electronic component 100 may not be damaged due to hydrogen gas generated in the plating process.

In particular, the alloy layers 31b and 32b are formed by a primary dipping process at a high temperature, and the plating layers 31c and 32c are formed by a secondary dipping process at a low temperature. This will be described in detail in a manufacturing method of the electronic component 100.

Hereinafter, a manufacturing method of the electronic component 100 according to an embodiment of the invention will be described. In the present embodiment, a manufacturing method of a multilayer ceramic capacitor as the electronic component 100 will be described as an example; however, the present invention is not limited thereto.

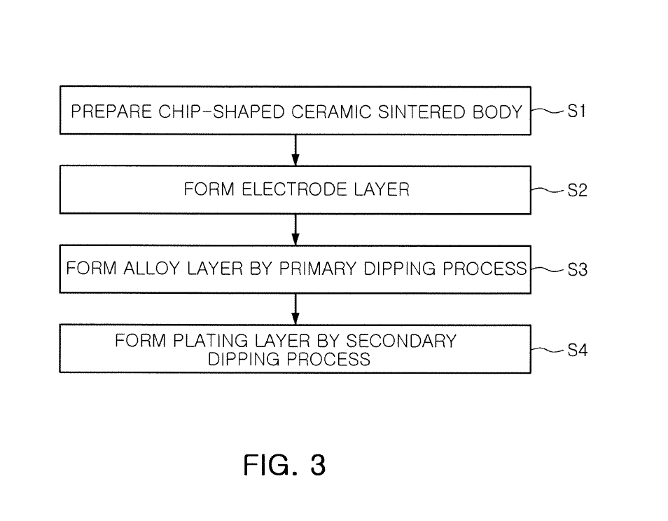

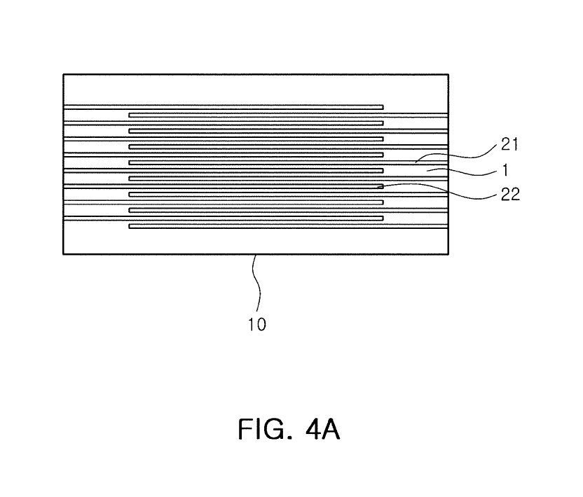

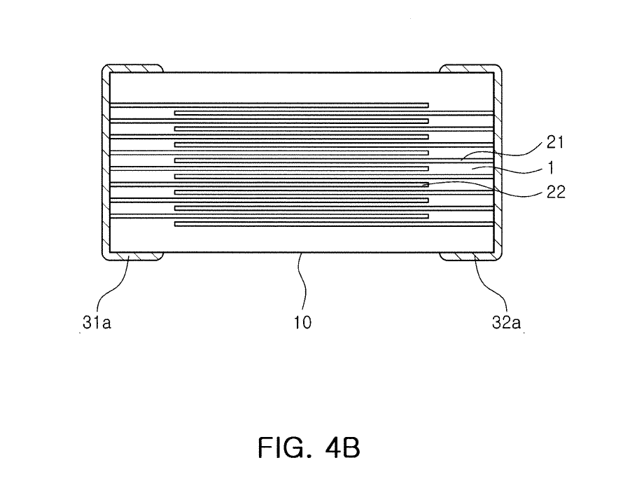

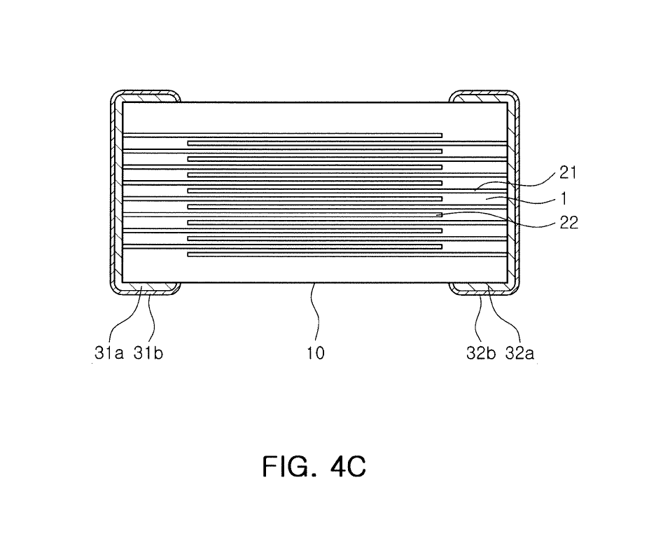

FIG. 3 is a flowchart schematically showing a manufacturing method of the electronic component shown in FIG. 1, and FIGS. 4A to 4C are cross-sectional views illustrating the manufacturing method of the electronic component of FIG. 3.

Referring to FIGS. 3 and 4A to 4C, in the manufacturing method of the electronic component 100, that is, the multilayer ceramic capacitor, according to the present embodiment, a ceramic sintered body 10 having a chip shape is prepared as shown in FIG. 4A (S1).

The shape of the ceramic sintered body 10 may be a rectangular; however, the present invention is not limited thereto.

The preparing of the chip shaped ceramic sintered body 10 is not particularly limited, and the ceramic sintered body 10 may be prepared by a general manufacturing method of a ceramic laminated body.

More specifically, a plurality of ceramic green sheets are prepared. Here, each ceramic green sheet may be obtained in a manner such that a ceramic powder, a binder, a solvent are mixed to manufacture a slurry, and the slurry is manufactured as a sheet having a thickness of several μm by a doctor blade method.

Next, a conductive paste for internal electrodes 21 and 22 is coated on an outer surface of the ceramic green sheet, thereby forming an internal electrode pattern. In this case, the internal electrode pattern may be formed by a screen printing method; however, the present invention is not limited thereto.

The conductive paste may be manufactured by dispersing a powder formed of nickel (Ni) or a nickel (Ni) alloy in an organic binder and an organic solvent.

Here, the organic binder known in the related art may be used; however, the present invention is not limited thereto. For example, cellulose resin, epoxy resin, aryl resin, acrylic resin, phenol-formaldehyde resin, unsaturated polyester resin, polycarbonate resin, polyamide resin, polyimide resin, alkyd resin, rosin ester, or the like may be used therefor.

Also, the organic solvent known in the related art may be used; however, the present invention is not limited thereto. For example, butyl carbitol, butyl carbitol acetate, oil of turpentine, α-terpineol, ethyl cellosolve, butyl phthalate, or the like may be used therefor.

Next, the ceramic green sheets on which the internal electrode pattern is formed are laminated and pressurized, and the laminated ceramic green sheets having the internal electrode pattern are compressed.

When a ceramic laminated body in which the ceramic green sheets and the internal electrode pattern are alternately laminated is manufactured, the ceramic laminated body is fired and cut to thereby prepare the chip-shaped ceramic sintered body 10.

Thus, the ceramic sintered body 10 may be formed in a manner such that the plurality of dielectric layers 1 and the internal electrodes 21 and 22 are alternately laminated.

Next, as shown in FIG. 4B, the electrode layers 31a and 32a are formed on the outer surface of the ceramic sintered body 10 (S2).

The electrode layers 31a and 32a are formed of copper (Cu). However, the present invention is not limited thereto.

In addition, the electrode layers 31a and 32a are formed in a manner such that a conductive paste prepared by adding a glass frit to the copper (Cu) powder is coated on the outer surface of the ceramic sintered body 10, and then fired.

A method of coating the conductive paste is not particularly limited, and for example, dipping, painting, printing, or the like may be used.

Next, as shown in FIG. 4C, the alloy layers 31b and 32b are formed on the electrode layers 31a and 32a by a primary dipping process (S3).

The alloy layers 31b and 32b according to the present embodiment are provided to suppress the electrode layers 31a and 32a formed of copper (Cu) from being leached by the molten solder as described above.

In the manufacturing method of the electronic component according to the present embodiment, the alloy layers 31b and 32b and the plating layers 31c and 32c are formed by the dipping method. The forming of the alloy layers 31b and 32b may be performed by dipping the electrode layers 31a and 32a of the electronic component 100 in a first molten solder having metals melted therein.

The alloy layers 31b and 32b may be formed of a copper (Cu)-tin (Sn) alloy containing nickel (Ni) as described above. Accordingly, the first molten solder used for forming the alloy layers 31b and 32b may include copper (Cu), tin (Sn), and nickel (Ni).

Thus, when the electrode layers 31a and 32a are dipped in the molten solder, they react with copper (Cu) and tin (Sn) of the molten solder to thereby form the copper (Cu)-tin (Sn) alloy layers 31b and 32b, formed as thin films, on the outer surfaces of the electrode layers 31a and 32a. In this process, the nickel (Ni) contained in the first molten solder is evenly dispersed in the copper (Cu)-tin (Sn) alloy layers 31b and 32b.

In this manner, the nickel (Ni) is dispersed within the copper (Cu)-tin (Sn) alloy layers 31b and 32b, so that the excessive growth of the copper (Cu)-tin (Sn) alloy layers 31b and 32b is suppressed as described above.

In addition, the alloy layers 31b and 32b are formed by dipping the electrode layers 31a and 32a in the first molten solder for a significantly short time. This will be described in detail below.

The first molten solder according to the present embodiment may have a high melting temperature of 260° C. or more by the composition, that is, copper (Cu), tin (Sn), and nickel (Ni).

However, when dipping is performed at a high temperature as described above, heat is continuously applied to the copper (Cu)-tin (Sn) alloy layers 31b and 32b, so that the copper (Cu)-tin (Sn) alloy layers 31b and 32b are rapidly grown. Accordingly, when a long dipping time is set, the thickness of the copper (Cu)-tin (Sn) alloy layers 31b and 32b may be increased, so that the performance of the electronic component 100 may be degraded.

Accordingly, in the manufacturing method of the electronic component according to the present embodiment, a significantly short dipping time may be set in the forming of the alloy layers 31b and 32b. Specifically, this primary dipping process may be performed within several seconds. However, the present invention is not limited thereto, and the dipping time may be adjusted depending on a temperature of the first molten solder or a composition ratio of the first molten solder.

Next, the plating layers 31c and 32c are formed by a secondary dipping process (S4).

As described above, in the manufacturing method of the electronic component according to the present embodiment, the plating layers 31c and 32c are also formed by a dipping method. Accordingly, the plating layers 31c and 32c may be formed by dipping the alloy layers 31b and 32b of the electronic component 100 in a second molten solder having metals melted therein.

The plating layers 31c and 32c may be formed of tin (Sn) containing bismuth (Bi) as described above. The second molten solder used for forming the plating layers 31c and 32c includes tin (Sn) and bismuth (Bi), and further includes silver (Ag) in order to increase a bonding strength between metals.

Meanwhile, the forming of the plating layers 31c and 32c may be performed for a relatively longer dipping time in comparison with that of the above-described alloy layers 31b and 32b. Also, the dipping process is performed at a lower temperature than that of the first molten solder. This will be described in detail below.

As described above, when the dipping process is performed at a high temperature, heat is continuously applied to the copper (Cu)-tin (Sn) alloy layers 31b and 32b, so that the copper (Cu)-tin (Sn) alloy layers 31b and 32b are rapidly grown.

Accordingly, to suppress the growth of the alloy layers 31b and 32b, the forming of the plating layers 31c and 32c according to the present embodiment may be performed at a low temperature of 220° C. or lower (for example, about 150° C. to 220° C.). The second molten solder according to the present embodiment includes bismuth (Bi) to lower the melting temperature as described above.

When the melting temperature is lowered, the growth of the alloy layers 31b and 32b due to heat applied thereto may be suppressed in the secondary dipping process.

When the copper (Cu)-tin (Sn) alloy layers 31b and 32b are dipped in the second molten solder, they react with the tin (Sn) of the second molten solder, so that the plating layers 31c and 32c are formed.

In this case, since the alloy layers 31b and 32b are already formed on the outer surfaces of the electrode layers 31a and 32a, the electrode layers 31a and 32a are protected by the alloy layers 31b and 32b, thereby suppressing the leaching of the electrode layers 31a and 32a. In addition, since the second molten solder is formed at a lower temperature, a possibility in which the electrode layers 31a and 32a are leached may be reduced.

The manufacturing method of the electronic component according to the present embodiment may suppress the leaching of the electrode layers 31a and 32a, so that the plating layers 31c and 32c are easily formed on the outer surfaces of the electrode layers 31a and 32a through the dipping method. The plating layers 31c and 32c are formed to thereby completely manufacture the electronic component 100 according to the present embodiment as shown in FIG. 2.

The manufacturing method of the electronic component according to the embodiment of the invention includes forming the plating layers by using the dipping method in a manner such that the electrode layers are dipped in the molten solder, rather than the related art method in which a plating solution is used in the forming of the external electrode.

When the plating solution penetrates into the external electrodes, the reliability of the electronic component may be significantly deteriorated due to degradation occurring by the reaction between the plating solution and the internal electrodes.

In addition, electroplating is performed in a state in which the plating solution penetrates into the external electrodes, or the plating solution penetrates into the ceramic sintered body, the ceramic sintered body may be damaged due to pressure caused by hydrogen generated in the plating process.

However, since the manufacturing method of the electronic component according to the present embodiment does not include the plating process using the plating solution, the plating solution does not penetrate into the electronic component, or the electronic component is not damaged due to the hydrogen gas generated at the time of the plating process. Accordingly, the reliability of the electronic component may be significantly improved.

In addition, in the manufacturing method of the electronic component according to the present embodiment, the plating layers are formed after the forming of the alloy layers, while the copper electrode layers are suppressed from being leached due to a high temperature. Accordingly, even in the case of the use of the molten solder having a high temperature, the plating layers may be easily formed on the outer surfaces of the electrode layers.

In addition, the alloy layers according to the present embodiment may be formed of the copper (Cu)-tin (Sn) alloy containing nickel (Ni). Accordingly, even when heat is generated on the alloy layers during the manufacturing process there of or during the use thereof, the alloy layers are suppressed from being continuously grown by the heat. Accordingly, deterioration in the performance of the electronic component due to the excessive growth of the alloy layers may be prevented.

Meanwhile, the electronic component and the manufacturing method thereof are not limited to the above-described embodiments, and various modifications can be made by those skilled in the art without departing from the spirit and scope of the invention.

For example, the multilayer ceramic capacitor and the manufacturing method thereof have been described in the above-described embodiments as an example; however, the present invention is not limited thereto. Any electronic component may be widely employed as long as it has a plating layer provided on an external electrode formed on an outer surface of an electronic component body.

While the present invention has been shown and described in connection with the embodiments, it will be apparent to those skilled in the art that modifications and variations can be made without departing from the spirit and scope of the invention as defined by the appended claims.

What is claimed is:

1. An electronic component, comprising:
a ceramic sintered body having a plurality of internal electrodes formed therein; and
external electrodes formed on an outer surface of the ceramic sintered body,
wherein each of the external electrodes includes a copper (Cu) electrode layer electrically connected to the internal electrodes, a copper (Cu)-tin (Sn) alloy layer formed on an outer surface of the electrode layer, and a tin (Sn) plating layer formed on an outer surface of the alloy layer.

2. The electronic component of claim 1, wherein the alloy layer includes nickel (Ni).

3. The electronic component of claim 1, wherein the plating layer includes bismuth (Bi).

4. A manufacturing method of an electronic component, the manufacturing method comprising:
preparing a ceramic sintered body;
forming at least one electrode layer on an outer surface of the ceramic sintered body;
forming an alloy layer by a primary dipping process of dipping the electrode layer in a first molten solder; and
forming a plating layer by a secondary dipping process of dipping the alloy layer in a second molten solder.

5. The manufacturing method of claim 4, wherein the electrode layer is formed of copper (Cu).

6. The manufacturing method of claim 4, wherein the first molten solder is formed of a composition including nickel (Ni), copper (Cu), and tin (Sn).

7. The manufacturing method of claim 6, wherein the alloy layer is formed of a copper (Cu)-tin (Sn) alloy including nickel (Ni).

8. The manufacturing method of claim 4, wherein the second molten solder is formed of a composition including tin (Sn) and bismuth (Bi).

9. The manufacturing method of claim 8, wherein the plating layer is a tin (Sn) plating layer including bismuth (Bi).

10. The manufacturing method of claim 4, wherein the primary dipping process is performed by using the first molten solder having a high temperature, and
the secondary dipping process is performed by using the second molten solder having a low temperature.

11. The manufacturing method of claim 10, wherein the first molten solder is melted at a temperature of 260□ or higher, and
the second molten solder is melted at a temperature of 220□ or lower.

12. The manufacturing method of claim 4, wherein the primary dipping process is performed for a shorter time than that of the secondary dipping process.

13. The manufacturing method of claim 4, wherein the electronic component is a multilayer ceramic capacitor.
